(19) United States
(12) Patent Application Publication
(10) Pub. No.: US 2008/0249954 A1
(43) Pub. Date: Oct. 9, 2008

(54) World uranium mining index and tradeable investment products resulting therefrom

(76) Inventors: Boris Gleyzer, Huntington, NY (US); Yury Rubinovich, New York, NY (US)

Correspondence Address: Mitchell A. Stein, Esq.;STEIN LAW, P. C., Suite 4, 24 Woodbine Avenue, Northport, NY, 11768, US

(21) Appl. No.: 11/732,169

(22) Filed: Apr. 3, 2007

(51) Int. Cl. G06Q 40/00

(52) U.S. Cl. 705/36 R

(57) ABSTRACT

A world uranium mining index (“WUMI”) incorporating at least one mining company (i) with investable shares, comprising application of the following:

$$W U M I = {S}_{i} {\sum }_{i = 1}^{n} {IS}_{i} * {R}_{i} * {A}_{i} * {C}_{i} * {B}_{i} * {P}_{i}$$

wherein:

Si=scaling factor, Si=K*10−x, 0<K≦1 and 0≦x≦10;

n=number of mining companies (i), 10>n>100;

ISi=number of investable shares;

RAi=revenue/asset multiplier, 0<RAi≦1;

Ci=capping multiplier, 0<Ci≦1;

Bi=re-balancing multiplier,

Pi=price of a share in the mining companies (i).

Bi and Si act to rebalance the WUMI, after an event, such as: (a) change in the identity of issues; (b) stock split; (c) change in classes of stock; (d) special dividends; (e) event that, without rebalancing, would render the WUMI amount an inadequate representation of the mining companies' (n) performance. WUMI is applied by using a series of calculations periodically and thereafter plotted. An ETF is also shown, in which the unit price is determined as a quotient of the WUMI times a number selected to render the ETF an investment vehicle. A fund and a futures contract is shown based upon the WUMI calculation.

### FIELD OF THE INVENTION

The present invention relates to the field of investments, and more specifically to an index to provide information concerning the performance of companies involved in the production, development and exploration of uranium mining, and investment products associated therewith.

### BACKGROUND OF THE INVENTION

Uranium is quickly becoming a worldwide commodity with a significant market, as the number of nuclear reactors proliferate and uranium mining companies are called upon to supply fuel-grade uranium for use in these reactors. Fuel grade uranium is typically traded in the form of U₃O₈ (“U3O8”). In recognition of an expanding uranium production industry, the instant invention comprises an informational index for key uranium mining companies, and investment products resulting from the employment of this index. The instant index incorporates, among other things, market related data concerning a series of key uranium companies that fall within three sectors: producers, developers and exploration. The series of companies are then evaluated and mathematically profiled based upon an inventive business method, from which an index of the series is produced. The index is viable for tracking past performance of uranium mining companies and serves as the basis for a number of investment products, as explained hereinbelow. When the index is tracked over time, it closely resembles the performance of the uranium companies and the underlying uranium market, thereby adding efficacy to the underlying inventive business method.

It can be observed that the index is valuable in and of itself, as a resource for showing the performance of its underlying commodity (uranium) and the companies that mine the same. Moreover, when combined properly and utilized, it serves as a basis for a plurality of financial products, including one or more mutual or hedge funds (wherein investors purchase an interest in the fund and the fund managers follow the market of the mining companies and invest based upon predictions determined, at least in part, from the index), exchange traded funds (wherein investors purchase one or more units that reflect a static acquisition of a specific portfolio of uranium mining companies' stocks) and investment in the futures market (where purchases and sales are based upon predictions and volatility of the underlying companies and raw materials).

The invention comprises a business system based upon a proprietarily constructed, and herein coined phrase, World Uranium Mining Index (“WUMI”). WUMI is a capitalization-weighted capped index. WUMI comprises collected information, mathematically compiled of a selected group of key international players in the uranium mining industry. As a result of the efficacy of WUMI's tracking methodology it is also employed for hedge funds, mutual funds, futures trading, and exchange-traded funds (“ETFs”), all specific to the uranium mining industry.

By way of background, the concept of ETFs first emerged in the United States in 1993 with the creation of the Standard & Poor's Depositary Receipt (“SPDR”). Since 1993, ETFs have evolved into an entirely new investment category. An ETF is a mutual fund (which has a net-asset value), but trades like a market-based security. Similar to an index fund, an ETF incorporates a plurality of stocks that reflect an index. The index is typically calculated by an independent company. Accordingly, an investor typically has no idea what companies or products make up the index. Instead, it is left to those who run the index to decide what companies or products should be included, which may vary by the day, hour, minute, or second. Thus, ETFs are ideal vehicles for the WUMI's created herein.

Unlike mutual funds which have static net-asset values, an ETF's price changes throughout the day, as the supply and demand fluctuates. Therefore the performance for that ETF will change rapidly. Notably, ETFs are not limited to once-a-day trading at the end of the day, thereby again differentiating ETFs from mutual funds. In effect, a purchaser of one or more units in an ETF is bargaining upon the future performance of the ETF, which depends from the underlying stock that comprise the ETF. The WUMI calculation results in a whole number (preferably 5 digits, as discussed below) which serves as the basis of “per unit” price in the WUMI-ETF. One or more units in the WUMI-ETF when acquired by an investor is thereafter itself tradeable.

ETFs allow diversification over an index fund with the flexibility of a market-based security. The diversification aspect reduces investment risk. Like market-based securities, ETFs can be short sold, limit ordered, stop-loss ordered, bought on margin, or purchased in individual shares. Also likened to the market-based security situation, when buying or selling an ETF, the broker gets paid a standard commission. Today, there are hundreds of ETFs trading on the open market.

There are four (4) main types of ETFs: (1) broad-based ETFs, (2) fixed-income ETFs, (3) international ETFs, and (4) sector ETFs. Broad-based ETFs track a variety of indexes, fixed-income ETFs track indexes for corporate and Treasury bonds, international ETFs track indexes over one or more foreign countries, and sector ETFs track specific industries. The product of the instant invention involves the fourth type of ETFs, sector ETFs, specifically an ETF for the uranium mining industry. However, rather than track the entire uranium mining sector, the WUMI-ETF product of the instant invention involves specific quantities of stock in selected uranium mining companies, worldwide.

Due to the many variations of ETFs and their flexibility, they can be used for many different investment strategies including: (1) core investment, (2) portfolio diversification, (3) hedging, (4) cash management, (5) rebalancing, and (6) tax loss strategy. Accordingly, ETFs appeal to both institutional and retail investors for long-term holding and for selling short and hedging strategies. Due to the many advantages of ETFs, they are a widely used investment strategy.

ETFs are industry-specific. For example, ETFs have been established for the gold and oil industries, just to name a couple. (It should be appreciated that there is no exchange market for uranium, different from other types of commodities. Thus, trading the underlying by an investor is not, at least at present, an option.) Formula(s) employed for a particular ETF cannot be applied to an industry other than the specific industry underlying the ETF. This is, in large part, due to the fact that there are a substantial amount of factors that may effect a given industry, factors which are unique to that particular industry. For example, uranium for energy production is generally obtained by mining. It should be appreciated that atomic reactors utilize uranium for providing energy. The uranium is provided principally by mining companies. Hence these companies include producers, developers and exploration entities. Accordingly, the instant invention involves evaluation of the uranium mining industry, a business formula-metric method and system, called an index, and more particularly herein a “WUMI” to track the past performance of key mining companies and serve as a foundation for the WUMI-based investment products discussed herein.

Selection of the underlying uranium mining companies involves the use of certain conditions, including uranium mining companies' resources (history and quality of deposits, etc.) and their particulars (geography, local logistics, legal and regulatory situations), as well as environmental differences.

The uniqueness of the current uranium U308 market is a result of the legacy left from the days of the last uranium boom, in a form of data bases, uranium properties, some development and even production capabilities. Many uranium-related properties were once held by the minerals/uranium divisions of major oil companies, and had been explored by a major U.S. and international oil and gas companies, leading mining companies, government agencies, and universities. The scale and quality of such exploration and infrastructure build-up was exceptional, as uranium production was previously considered to be an issue of national security, and, as a result, much was either put on hiatus or abandoned during the period of decline of the nuclear power industry. These assets, and the knowledge base, cost hundreds of millions of dollars to create. These properties represent great value, and those companies which have been able to obtain these data bases and properties at low costs will have significant advantage over their competition.

There are currently over 400 uranium mining companies whose stock is publicly traded, the majority of them being either Canadian and Australian. The known uranium mining companies differ quite significantly as far as their market capitalization, and may be divided into three main categories. The first category of uranium mining companies is production. Production stage companies include issuers engaged in exploitation of a mineral deposit (reserve). The second category of uranium mining companies is development. Development stage companies include issuers engaged in preparation of established commercially minable deposits (reserves) for its extraction, but which are not in the production stage. The third category of uranium mining companies is exploration. Exploration stage companies include issuers engaged in search of mineral deposits (reserves) which are not in either the development or production stage.

Presently, there are at least eight (8) major uranium mining companies which include major U3O8 providers like BHP Billiton, Rio Tinto, Areva and Cameco. Of these, certain uranium providers that contribute a large share to the world uranium production show revenue received from uranium sales as but a small fraction of total sales. For example, Areva receives only 5% of their revenue from uranium sales, Rio Tinto gets just 2% of total company's revenues from uranium, a number which is even lower for BHP Billiton. Yet, BHP Billiton has a market capitalization at about $120 billion, and Rio Tinto at about $70 billion. In other words, these companies mine a number of resources, and uranium accounts for but a fraction of their revenue. This situation will be changing somewhat, as these companies increase their uranium production, but uranium revenue will likely still remain but a small portion of total sales. In comparison, Cameco, with a market capitalization of about $15 billion, has a much higher uranium revenue to gross revenue ratio, while its total value is but ten percent of that of BHP Billiton. This factor is critical, in that a pure Dow Jones or S&P 500-styled index that merely tracks company performance based upon market capitalization (or the quotient of shares outstanding of share price) would inaccurately relate to uranium production since the largest companies are involved in mining many materials other than uranium. In this manner, the influence of uranium is of minor, fractional significance to such companies, and an index based thereupon, without a business-based mathematical modification, would not be reflective of actual uranium production and sales. Stated another way, if one company received a major “hit” in connection with mining a material other than uranium (which may be a staple to that company), and its value deteriorates as a result, the effect on an index that merely includes market capitalization without more would be significant, but not be indicative of uranium. Indeed, the outcome from such an index would be misleading, as uranium sales were not effected although the company was effected by sales independent from uranium. Importantly, WUMI accounts for the ratio of uranium to other products to eliminate wide swings unrelated to uranium but resulting from other operations of these large entities.

In 2005, the eight (8) biggest uranium mining companies, which produce more than 1000 tons of uranium annually, accounted for 78% of world mine production. The biggest and closest to a “pure” uranium player is a large Canadian company called Cameco, with approximately $15 billion in market capitalization at the end of 2006. Cameco provides about 28% of the western world's uranium production, satisfying 20% of the world uranium fuel demand, and is the world's biggest uranium producer. Yet, Cameco is small in market value compared to others like BHF Billiton.

Another distinct group, as far as the market capitalization is concerned, comprises smaller uranium metal producers, as well as several companies that are termed to be “near producers” (companies, which are 1-2 years away from producing uranium) with market capitalizations ranging from $500 million to $5 billion.

There are also smaller development and exploration companies with a market cap of about $50 to $500 million. Closing the rear, there is a multitude of early exploration firms, generally ranging from about $20 to $50 million in market capitalization.

WUMI as designed herein, comprises companies that vary greatly in market capitalization, which are pursuing various types of mining activities, and differ in magnitude and quality of their mineral deposit (reserve) base. Mining methods that are currently being utilized, or (planned) by a particular company—whether open pit or underground mining, or a relatively new In-Situ Leaching (ISL) method—depend on the very type and particulars of those deposits, their geographical region specifics and logistics, local regulatory and environmental situations and the like. All of these factors are reflected in the ultimate cost of uranium metal production, amount of capital expenditures required to build and operate a particular mine, as well as the time needed for project completion. To invest in the uranium development market, it is vitally important to filter and utilize all this information, and to be able to estimate a company's future uranium prospects. It is necessary to have a thorough understanding of the uranium mining industry, immediate access to the latest industry news, and individual companies' information, and proper resources for the execution of a selected strategy. It is an object of the instant invention to accumulate such information, provide a WUMI for investors to rely upon based upon the proprietary business formulae, which include such considerations therein.

Additionally, the wave of merges and acquisitions for uranium mining companies has started: small companies have merged to achieve economy of scale. Producing uranium mining companies acquire uranium mining exploration and development companies in order to obtain access to more valuable resource properties, and a larger market share than other uranium mining producers. Large exploration and development uranium mining companies are also acquiring smaller uranium mining companies to create a bigger market value and price, before they, too, are acquired. Some uranium mining companies that have uranium processing facilities are and will be acquiring uranium mining companies who have resources, and vice versa, in order to create vertically integrated companies.

Companies such as BHP, or Rio Tinto, apparently understand the fast growing value of uranium assets and will be increasing their uranium holdings. The same will apply to the oil majors, who will likely be acquiring uranium mining companies to diversify their energy resource portfolios. History demonstrates that these events are typical. For example, in the 1960s and 1970s large oil & gas companies were involved in extensive uranium exploration and mining. During this period, a French oil major (Total) showed significant investment in uranium exploration in Australia and Africa, and a large American oil & gas company (Kerr McGee) was also involved in uranium exploration and development in the United States.

It is observable that utilities will likely be the most eager purchasers of uranium mining companies. Specifically, utilities that utilize reactors for energy production will need to secure an uninterrupted supply of uranium fuel for themselves at locked-in prices, in comparison to an otherwise apparent need to “chase” uranium in an open-market at potentially skyrocketing prices.

In order to perform effectively, the number of entities that are considered in the WUMI formulae is predetermined. Yet, the specific entities are not static, as there is a need, from time to time, to swap out companies from and to the index, as one or more companies become more or less significant players in the uranium sector. WUMI thus employs a rather static number of companies, but a dynamic nature to the specific companies listed. Should an acquisition or divestment occur, this change must have a consequence to the index, in order for the index to provide valuable tracking. Thus, mining companies are watched closely, and listing in the WUMI is carefully determined based upon many factors that include companies that are most probable acquisition targets, as well as in the acquiring companies and their concomitant growth and stability as producing industry leaders.

Heretofore known are methods that suggest the ability to predict the future performance of a particular industry. This is hence distinguishable from the instant invention which involves a formula for past performance as a basis for creating investment products. For example, U.S. Pat. No. 5,974,403 to Takriti et al. shows a method to forecast the spot price of electric power in a deregulated market and the amounts of power that may be traded in the electric power market by evaluating market information. However, the instant invention, unlike that shown in Takriti, does not determine spot pricing of the underlying uranium commodity.

Also shown are methods to purportedly predict the future performance of a hedge fund. For example, U.S. Pat. No. 7,099,838 to Gastineau et al. shows a product which suggestively determines the basket of hedging instruments by extracting factor information from a portfolio of the actively managed exchange traded fund and determining factors that affect the price of the exchange traded fund.

Also shown are methods to predict the future performance of certain publicly traded securities. For example, U.S. Pat. No. 6,119,103 to Basch et al. shows a method to measure financial risk by scoring transaction data from multiple accounts. U.S. Pat. No. 7,194,434 to Piccoli shows a method of forecasting the short run trend based on various factors and market indicators which analyze multiple time series associated with the target data which are examined to locate continuous trends or subseries. U.S. Pat. No. 5,819,237 to Garman shows a method to determine the incremental impact of any number of candidate trades on the value at risk measure of a trading portfolio within a trading interval. U.S. Pat. No. 5,806,049 to Petruzzi shows a data processing system for determining a matrix of optimal investment portfolios based on globally assessed investment return and risk criteria.

However, while prediction may be the province of a desire shown by these patents, it is inherently not part of the instant invention. It is therefore an object of the instant invention to provide a product that accurately tracks past performance of uranium mining companies by evaluating key players, and provides investment vehicles upon such tracking, all as more fully disclosed hereinabove.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be made to the drawings and descriptive matter in which there are illustrated and described preferred embodiments of the invention.

A world uranium mining index is shown and claimed herein for business purposes (“WUMI”) incorporating at least one mining companies (i) with investable shares of stock, comprising application of the following formula:

$$W U M I = {S}_{i} {\sum }_{i = 1}^{n} {IS}_{i} * {RA}_{i} * {C}_{i} * {B}_{i} * {P}_{i}$$

wherein:
Sᵢ=a scaling factor, wherein Sᵢ=K*10^{-x}, wherein 0<K≦1 and 0≦x≦10, and preferably such that x=6;
n=the total number of each of the at least one mining companies (i) in the WUMI, wherein preferably 10>n>100 and more preferably n=30;
ISᵢ=the total number of investable shares;
RAᵢ=a revenue/asset multiplier, wherein 0<RAᵢ≦1;
Cᵢ=a capping multiplier, wherein 0<Cᵢ≦1;
Bᵢ=a periodic re-balancing multiplier, and
Pᵢ=the price of a share of stock in the at least one mining companies (i).
   Bᵢ is determined in conjunction with Sᵢ in order to need to rebalance the WUMI, after at least one event including, by way of example: (a) a change in the identity of at least one of the issues (i); (b) a split in the stock of at least one of the issues (i); (c) a change in the classes of stock of at least one of the issues (i); (d) declaring special dividends of at least one of the issues (i); (e) determined upon the happening of an event that, in the absence of rebalancing, would render the WUMI amount to be an inadequate representation of the underlying mining companies' (n) performance. The WUMI is often applied by setting forth a multiple series of such calculations on a periodic time basis and thereafter plotted. An ETF is also shown, created upon the basis of a WUMI, in which the price of a unit is determined as a quotient of the WUMI times a number selected in order to render the ETF a practical investment vehicle. Likewise, a fund and a futures contract are shown based upon the WUMI calculation.

Evaluations of products or industries are often grouped in to what are known as “indexes.” Important to an understanding of the instant invention is a knowledge of the uranium mining industry in order to accurately determine the correct variable. Moreover, due to the unique nature of the instant invention, unique variables are created, which specifically correlate to a certain aspect(s) of the uranium mining industry.

It is important to recognize that a WUMI is created at a particular point in time. As an index, multiple points in time, also known as a periodic time basis, are calculated and can be plotted over the periodic time basis. In this manner historical information is shown of the total number of underlying mining companies (n) of the WUMI.

Initially, at least one mining companies (i) are determined. It should be understood that such companies fall into the three sectors indicated, and meet certain criteria that are comprehensible by one of ordinary skill in the art upon reading the instant disclosure and claims. Moreover, the index comprises at least one (i) and preferably a total number (n) between 10 and 100, and more preferably 30. At 30 companies, the index is a stable environment predicated upon key uranium mining companies, individually referred to as (i) in the formula, with a total of (n) therein.

The scaling factor (Sᵢ) is determined to render the final index within a certain predefined whole number, preferably having total number of digits of 5, resulting from the quotient of K and 10^{-x}. The scaling factor provides the resultant total number of digits in the WUMI, as shown in greater detail hereinbelow.

ISᵢ indicates the total number of investable share of stock. In other words, such shares are those that are freely tradeable on the open market, with no restrictions, and are available for purchase or sale as such. This number is provided by publicly available sources through the exchanges in which the underlying mining company's shares are traded.

RAᵢ indicates a revenue/asset multiplier. In this respect, the WUMI takes into consideration the revenue generated (as well as all potential revenue that may be generated) for the specific asset of uranium and allows the WUMI to rate companies not just on market capitalization, but upon the ratio of how much uranium as an asset accounts for its revenue. This seeks to balance the situation where, like BHP, a small amount of revenue is accounted for by uranium and to permit its inclusion as a company in the index without its large market capitalization (which depends from the sale of resources other than uranium) from overwhelming smaller valued companies whose ratio of uranium production is larger.

Similarly, a capping multiplier Cᵢ is used to also balance the WUMI by limiting undue influence over the index by capping the percentage of any single company (i) component in the index.

Bᵢ as defined above, allows a re-balance of the WUMI where, for example, one company is swapped with another, or has had a serious change in its structure or valuation. In this manner, the WUMI is maintained in a stable way. For example, if a company is swapped with another and there is a significant difference in market capitalization, the re-balancing multiplier is employed to re-balance the WUMI and eliminate the consequence of the swapping.

Lastly, Pᵢ is the published, or otherwise reported, price of stock in the designated mining company (i).

Accordingly, the product of the instant invention seeks to take into account the performance of key international players in the uranium mining index. As such, the product of the instant invention is not limited to the performance of uranium mining companies in a certain nation's market, but takes into account their activity in all international markets. WUMI indicates the uranium mining market based on a fixed number of uranium mining companies from around the world, wherever uranium mining stocks are traded. Indeed, most of the world's mining industry financing does not occur in the United States.

WUMI index covers almost all free-market uranium production, including a very high percentage of the world's uranium development and near-production capacity, and high percentage of major exploration companies. WUMI achieves the goal of balancing the portfolio of stocks in the index so as to (as fully as possible) represent a correlation between underlying uranium demand/supply fundamentals, and aggregate mining stocks prices, without allowing excessive influence of any specific company's particular situation on the overall WUMI index.

WUMI incorporates leading publicly traded uranium mining and production companies. These companies are selected according to a set of criteria, involving the size of its market capitalization, liquidity of shares, market float, revenues, assets, etc. These companies are typically traded on the Australian, European and North American exchanges, providing some measure of liquidity and offer the possibility to conduct reasonable due diligence on their finances and management. Notably, some of the uranium mining companies incorporated in WUMI do not exclusively mine uranium. Indeed, some of the companies that mine uranium incorporated in WUMI obtain only a small percentage of their annual revenue from uranium mining. Accordingly, WUMI is not directly effected by the mining of resources other than uranium, therefore making WUMI do more than simply reflect the supply and demand for uranium.

WUMI is calculated per a specific proprietary pricing formula adjusting share prices to account for differences in market capitalizations, assets and revenues of the index components.

It should be appreciated that a WUMI determines a whole number that serves as a suitable basis for a fund, and more specifically even an ETF. One of ordinary skill in the art can easily see that armed with the computational analysis as provided herein of the index (WUMI), an ETF has a discernable price, and hence can be traded on a multiple unit basis. Likewise, the more general group of funds is also easily determined based upon the periodic WUMI calculations.

Other features will become apparent from reading the disclosure and claims of the instant invention.

### BRIEF DESCRIPTION OF THE DRAWINGS

In the drawings, wherein similar reference characters denote similar elements throughout the several views:

FIGS. 1(A, B and C) together comprise a spreadsheet showing the calculation of a WUMI.

### DETAILED DESCRIPTION OF THE PREFERRED EMBODIMENTS

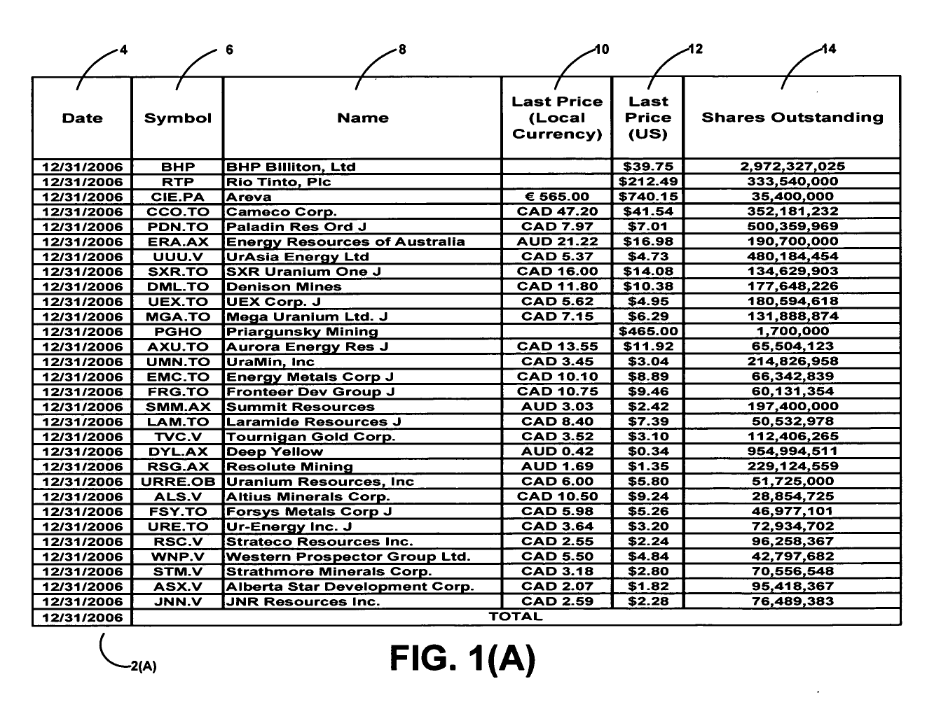

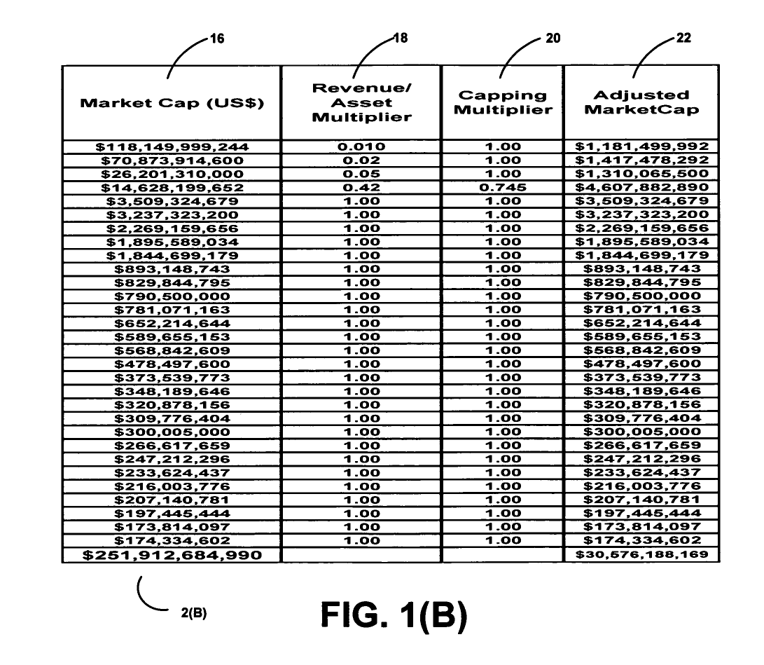

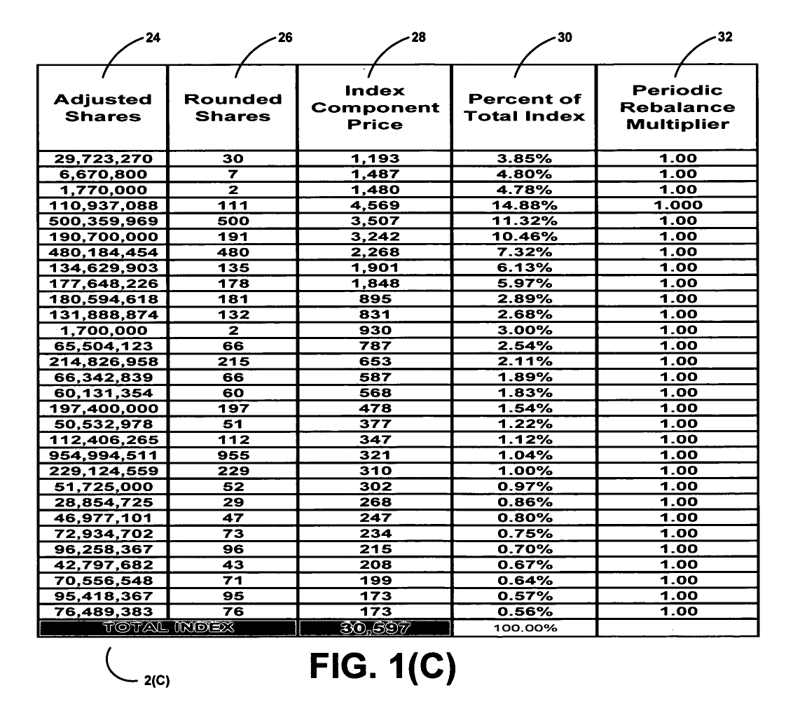

Shown in FIG. 1(A) is the first portion 2(A) of a spread sheet based upon the WUMI (index) set forth hereinabove. Column 4 indicates the date specific of the WUMI. As indicated, a multiple series of such indexes are also calculated on a periodic basis and graphed. This, while not directly shown, is a visible consequence when dates other than the one shown in column 4 are employed, and the period between one such calculation and the other serves as the x axis, with the resultant total index amount (shown in FIG. 1(C)) is graphed on the y axis.

Column 6 indicates the trading symbol of the underlying mining company. Each row, then, is a reference to that individual mining company (“i” in the WUMI). Likewise, column 8 indicates the name of the underlying, column 10 is the last price in its local currency (i.e., the country through whose monetary exchange the stock is traded), column 12 is the last price in U.S. dollars (although any other basis can be used in order to convert to one standard currency), and column 14 derives from publicly available data indicating the total amount of investable shares (freely tradeable as indicated) that are outstanding for each of the identified underlyings in each of the row.

Referring to FIG. 1(B), the next four columns 16, 18, 20 and 22 are shown. The market capitalization column 16 equals the investable shares outstanding (column 14) times the last price (column 12). As indicated hereinabove, revenue/asset multiplier column 20 permits the ratio of uranium to other assets to enter into the summed quotient, in accordance with the WUMI calculation, to eliminate the transient effects of assets other than uranium from impacting the WUMI, thereby rendering the WUMI a more complete indicator of uranium mining companies. Capping multiplier column 20 is used to also balance the WUMI by limiting undue influence over the index by capping the percentage of any single company (i) component in the index. In this case, Cameco is shown to have a capping multiplier of 0.745 (row 4) since it is the largest player strictly in uranium production. Fluctuation in Cameco from, e.g., its problems in Cigar Lake, will not unduly influence the WUMI as a result of the capping multiplier column 20. As a result of multiplying the market cap column 16 by the revenue/asset multiplier 18 and the capping multiplier column 20, adjusted market cap (i.e., a short hand for “capitalization”) column 22 is thereby created.

As shown in FIG. 1(C), column 24 indicates the adjusted shares, which is computed by division of the adjusted market cap (column 22) by a share price (column 12) for each indicated row. In this manner, an adjusted number of shares, takes into consideration the revenue/asset and capping multiplier's effect on adjusted market cap (column 22) is determined. This is important, as the adjusted shares are scaled and rounded to a whole number at column 26, and then an index component price at column 28. After the whole number is determined, it is multiplied by the actual last price in column 12, to determine the index component price at column 28 for each company represented by each separate row.

The sum of column 28 is applied, resulting the last row (entitled total index) which, in this case, indicates a WUMI at 30,597. It should be appreciated that a U.S. dollar per, this would indicate a unit price of 30,597 in a fund, which would represent an acquisition of each of the amount of rounded shares in the companies indicated in column 26.

To verify the WUMI, percent of total index column 30 is shown. In this instance, a target of under 15% is employed, such that no individual company can significantly impact the WUMI. Should one have exceed 15%, then adjustment via the capping multiplier (see column 20) would have been made to redetermine the percentage. In this instance, periodic re-balance multiplier, as applied in column 32, is shown as “1.” Yet, had there been, for example, a swapping of one underlying for another, this column would have a changed entry for the swapped underlying, if necessary.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A world uranium mining index for business purposes (“WUMI”) incorporating at least one mining companies (i) with investable shares of stock, comprising application of the following formula:
$$W U M I = {S}_{i} {\sum }_{i = 1}^{n} {IS}_{i} * {RA}_{i} * {C}_{i} * {B}_{i} * {P}_{i}$$
wherein:
Sᵢ=a scaling factor, wherein Sᵢ=K*10^{-x}, wherein 0<K≦1 and 0≦x≦10, and preferably such that x=6;
n=the total number of each of the at least one mining companies (i) in the WUMI, preferably wherein 10>n>100 and more preferably n=30;
ISᵢ=the total number of investable shares;
RAᵢ=a revenue/asset multiplier, wherein 0<RAᵢ≦1;
Cᵢ=a capping multiplier, wherein 0<Cᵢ≦1;
Bᵢ=a periodic re-balancing multiplier, and
Pᵢ=the price of a share of stock in the at least one mining companies (i).

2. The WUMI of claim 1, wherein Bᵢ is determined in conjunction with Sᵢ in order to rebalance the WUMI, upon the occurrence of at least one event including, by way of example: (a) a change in the identity of at least one of the issues (i); (b) a split in the stock of at least one of the issues (i); (c) a change in the classes of stock of at least one of the issues (i); (d) declaring special dividends of at least one of the issues (i); and (e) determined upon the happening of an event that, in the absence of rebalancing, would render the WUMI amount to be an inadequate representation of the underlying mining companies' (n) performance.

3. The WUMI of claim 1, wherein a multiple series of such indexes are calculated on a periodic time basis.

4. The WUMI of claim 3, wherein the multiple series are plotted over the periodic time basis.

5. The WUMI of claim 1, wherein an ETF is created upon the basis of a WUMI.

6. The ETF created in claim 5, wherein the price of a unit is determined as a quotient of the WUMI times a number selected in order to render the ETF a practical investment vehicle.

7. A fund comprising WUMI, as defined in claim 1, as its basis.

8. A futures contract comprising WUMI, as defined in claim 1, as its basis.
